(19) United States
(12) Patent Application Publication
(10) Pub. No.: US 2026/0025632 A1
(43) Pub. Date: Jan. 22, 2026

(54) RENDERING OF OCCLUDED AUDIO ELEMENTS

(71) Applicant: Telefonaktiebolaget LM Ericsson (publ), Stockholm (SE)

(72) Inventor: Tommy FALK, SPÅNGA (SE)

(73) Assignee: Telefonaktiebolaget LM Ericsson (publ), Stockholm (SE)

(21) Appl. No.: 18/992,781

(22) PCT Filed: Jun. 27, 2023
(86) PCT No.: PCT/EP2023/067505

§ 371 Date: Jan. 9, 2025

Related U.S. Application Data
(60) Provisional application No. 63/388,682, filed on Jul. 13, 2022.

(51) Int. Cl. H04S 7/00

(52) U.S. Cl. CPC H04S 7/304; H04S 2400/11; H04S 2400/15

(57) ABSTRACT

A method for rendering a spatially-bounded audio element having an interior representation and an exterior representation. The method includes determining a modifier (m) wherein m indicates an amount by which an extent of the audio element is occluded. The method also includes determining a transition region (TR) for the audio element based on m and a default TR (D_TR).

### TECHNICAL FIELD

Disclosed are embodiments related to rendering of occluded audio elements.

### BACKGROUND

Spatial audio rendering is a process used for presenting audio within an extended reality (XR) scene (e.g., a virtual reality (VR), augmented reality (AR), or mixed reality (MR) scene) in order to give a listener (e.g., a human listener) the impression that sound is coming from physical sources within the scene at a certain position and having a certain size and shape (i.e., extent). The presentation can be made through headphone speakers or other speakers. If the presentation is made via headphone speakers, the processing used is called binaural rendering and uses spatial cues of human spatial hearing that make it possible to determine from which direction sounds are coming. The cues involve inter-aural time delay (ITD), inter-aural level difference (ILD), and/or spectral difference.

The most common form of spatial audio rendering is based on the concept of point-sources, where each sound source is defined to emanate sound from one specific point. Because each sound source is defined to emanate sound from one specific point, the sound source doesn't have any size or shape. In order to render a sound source having an extent (size and shape), different methods have been developed.

One such known method is to create multiple copies of a mono audio element at positions around the audio element. This arrangement creates the perception of a spatially homogeneous object with a certain size. This concept is used, for example, in the “object spread” and “object divergence” features of the MPEG-H 3D Audio standard (see references [1] and [2]), and in the “object divergence” feature of the EBU Audio Definition Model (ADM) standard (see reference [4]). This idea using a mono audio source has been developed further as described in reference [7], where the area-volumetric geometry of a sound object is projected onto a sphere around the listener and the sound is rendered to the listener using a pair of head-related (HR) filters that is evaluated as the integral of all HR filters covering the geometric projection of the object on the sphere. For a spherical volumetric source this integral has an analytical solution. For an arbitrary area-volumetric source geometry, however, the integral is evaluated by sampling the projected source surface on the sphere using what is called a Monte Carlo ray sampling.

Another rendering method renders a spatially diffuse component in addition to a mono audio signal, which creates the perception of a somewhat diffuse object that, in contrast to the original mono audio element, has no distinct pin-point location. This concept is used, for example, in the “object diffuseness” feature of the MPEG-H 3D Audio standard (see reference [3]) and the “object diffuseness” feature of the EBU ADM (see reference [5]).

Combinations of the above two methods are also known. For example, the “object extent” feature of the EBU ADM combines the creation of multiple copies of a mono audio element with the addition of diffuse components (see reference [6]).

In many cases the actual shape of an audio element can be described well enough with a basic shape (e.g., a sphere or a box). But sometimes the actual shape is more complicated and needs to be described in a more detailed form (e.g., a mesh structure or a parametric description format).

Spatially-bounded audio elements with interior and exterior representations:

Some audio elements are of the nature that the listener can move inside a spatial boundary of the audio element and expect to hear a plausible audio representation also there. For these audio elements the extent acts as a spatial boundary that defines the edge between the interior and the exterior of the audio element. Examples of such audio elements could be: a forest (sound of birds, wind in the trees); a crowd of people (the sound of people clapping hands or cheering); a city square (sounds of traffic, birds, people walking).

When the listener moves within the spatial boundary of the audio element (i.e., the interior of the audio element), the audio representation should be immersive and surround the listener. As the listener moves out of the spatial boundary i.e., the exterior of the audio element, the audio should now appear to come from the extent of the audio element.

Although these audio elements could be represented as a multitude of individual point-sources, it is often more efficient to represent these with a single compound audio signal. For the interior audio representation, a listener-centric format, where the sound field around the listener is described, is suitable. Listener-centric formats include channel-based formats as 5.1, 7.1 and scene-based formats such as Ambisonics. Listener-centric formats are typically rendered using several speakers positioned around the listener.

But there is no well-defined way to render a listener-centric audio signal directly when the listener position is outside of the spatial boundary. Here a source-centric representation is more suitable since the sound source no longer surrounds the listener but should instead be rendered to be coming from a distance in a certain direction. A solution is to use listener-centric audio signal for the interior representation and derive a source-centric audio signal from that, which can then be rendered using source-centric techniques. This technique is described in reference [8] and the term used for these special kind of audio elements is spatially-bounded audio elements with interior and exterior representations. Further techniques of rendering the exterior representation of such an audio element, where the extent can be an arbitrary shape, is described in reference [9]. As described in reference [8] a transition region can be used to provide a smooth transition between the exterior and interior representations.

More specifically, reference [8] discloses a process for rendering a spatially-bounded audio element with interior and exterior representations where the process includes: determining a distance (d) between the listener and the spatial boundary of the audio element; determining whether the distance between the listener and the spatial boundary of the audio element is less than a certain transition threshold value (a.k.a., “transition distance (TD)”); and, as a result of determining that the distance is less than the transition distance TD, using both the exterior representation and the interior representation to render the audio element. That is, the process determines whether the listener is within a transition region, which is defined by the position of the audio element and one or more transition distances. If the listener is within the transition region, then the renderer using both the exterior representation and the interior representation to render the audio element.

### Occlusion

Occlusion happens when, from the viewpoint of a listener at a given listening position, an audio element is completely or partly hidden behind some object such that no or less direct sound from the occluded part of the audio element reaches the listener. Depending on the material of the occluding object, the occlusion effect might be either complete occlusion (a.k.a., “hard” occlusion), e.g., when the occluding object is a thick wall, or partial occlusion (a.k.a., “soft” occlusion) where some of the audio energy from the audio element passes through the occluding object, e.g., when the occluding object is made of thin fabric such as a curtain. Soft occlusion can often be well described by a filter with a certain frequency response that matches the acoustic characteristics of the material of the occluding object.

Occlusion is typically detected using raytracing where a set of one or more rays are sent from the listener position towards the position of the audio element and where any occlusions on the way are identified. This works well for point sources where there is one defined position for the audio element. However, for an audio element that has an extent this simple process is not directly applicable. In this case the whole extent needs to be checked for occlusion. Also, in the case that the audio element is a heterogeneous audio element where there is spatial information that should be rendered so that it appears to come from the extent of the audio object, special care is needed in order for this spatial information to be preserved.

### SUMMARY

Certain challenges presently exist. For example, the available solutions for rendering occlusion effects for spatially-bounded audio elements with interior and exterior representations operate on the exterior representation only. During the transition to the interior representation, if there is an occluder between the listener and the extent of the audio element, the interior representation should not be heard until the listener is entering into the extent. This means that the transition between the exterior and interior representation needs to be controlled for any occlusion.

Accordingly, in one aspect there is provided an improved method for rendering a spatially-bound audio element having an interior representation and an exterior representation. In one embodiment the method includes determining a modifier (m) that indicates an amount by which an extent of audio element is occluded (e.g., m is a function of a value specifying an amount by which the audio element is occluded (e.g., an amount by which the extent of the audio element is occluded)). The method also includes determining a transition region (TR) for the audio element based on m and a default TR (D_TR). If the listener is not in the TR and not within the boundary of the audio element, then the exterior representation of the audio element is rendered for the listener, if the listener is within the boundary of the audio element, then the interior representation of the audio element is rendered for the listener, and if the listener is within the TR, then a combination of the interior and exterior representations is rendered for the listener.

In another embodiment the method includes determining a modifier (m), wherein m indicates an amount by which an extent of the audio element is occluded. The method also includes producing a first combined audio signal (Sc1) for the audio element based on m, a signal (Si1) associated with the interior representation, and a signal (Se1) associated with the exterior representation.

In another aspect there is provided a computer program comprising instructions which when executed by processing circuitry of an audio renderer causes the audio renderer to perform the methods disclosed herein. In one embodiment, there is provided a carrier containing the computer program wherein the carrier is one of an electronic signal, an optical signal, a radio signal, and a computer readable storage medium. In another aspect there is provided a rendering apparatus that is configured to perform the methods disclosed herein. The rendering apparatus may include memory and processing circuitry coupled to the memory.

An advantage of the embodiments disclosed herein is that they provide a method to control the transition between the exterior and interior representation depending on any occluding objects between the listener and the extent of the audio element. The embodiments add very little extra complexity to the renderer since it makes use of existing occlusion information, and the control of the transition can be made with a few simple calculations.

### BRIEF DESCRIPTION OF THE DRAWINGS

The accompanying drawings, which are incorporated herein and form part of the specification, illustrate various embodiments.

FIG. 1 shows two point sources (S1 and S2) and an occluding object (O).

FIG. 2 shows an audio element having an extent being partially occluded by an occluding object.

FIG. 3. illustrates a spatially-bounded audio element and a transition region surrounding the audio element according to an embodiment.

FIG. 4. illustrates a spatially-bounded audio element and a transition region surrounding the audio element according to another embodiment.

FIG. 5 illustrates an example in which an audio element represents the interior sound of a room.

FIG. 6 illustrates a function according to an embodiment.

FIG. 7 is a flowchart illustrating a process according to an embodiment.

FIG. 8A shows a system according to some embodiments.

FIG. 8B shows a system according to some embodiments.

FIG. 9 illustrates a system according to some embodiments.

FIG. 10. illustrates a signal modifier according to an embodiment.

FIG. 11 is a block diagram of an apparatus according to some embodiments.

FIG. 12 is a flowchart illustrating a process according to an embodiment.

### DETAILED DESCRIPTION

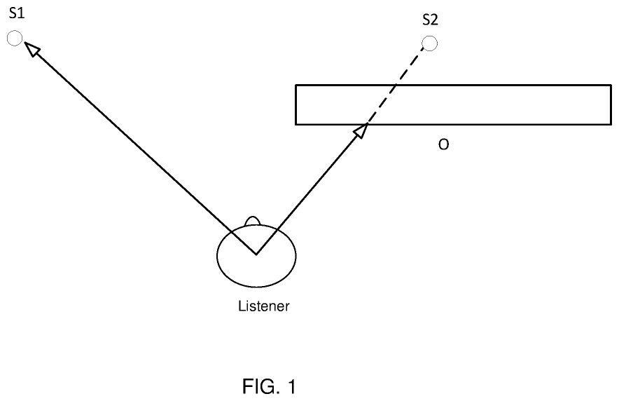

The occurrence of occlusion may be detected using raytracing methods where the direct sound path (or “path” for short) between the listener position and the position of the audio element is searched for any objects occluding the audio element. FIG. 1 shows an example of two point sources (S1 and S2), where one (i.e., S2) is occluded by an object (O) (which is referred to as the “occluding object”) and the other (i.e., S1) is not. In this case the occluded audio element S2 should be muted in a way that corresponds to the acoustic properties of the material of the occluding object. If the occluding object is a thick wall, the rendering of the direct sounds from the occluded audio element should be more or less completely muted.

For a given frequency range, any given portion of an audio element may be completely occluded, partially occluded, or not occluded. The frequency range may be the entire frequency range that can be perceived by humans or a subset of that frequency range. In one embodiment, a portion of an audio element is completely occluded in a given frequency range when an occlusion factor associated with the portion of the audio element satisfies a predefined condition. For example, a portion of an audio element is completely occluded in a given frequency range when an occlusion factor (which may be frequency dependent or not) associated with the portion of the audio element is less than or equal to a threshold value (T), where the value T is a selected value (e.g., T=0 is one possibility). That is, for example, any occluding object or objects that let through less than a certain amount of sound is seen as complete occlusion. In another embodiment there is a frequency dependent decision where the amount of occlusion in different frequency bands is compared to a predefined table of thresholds for these frequency bands. Yet another embodiment uses the current signal power of the audio signal representing the audio source and estimates the actual sound power that is let through to the listener, and then compares the sound power to a hearing threshold. In short, a completely occluded audio element (or portion thereof) may be defined as a sound path where the sound is so suppressed that it is not perceptually relevant. This includes the case where the occlusion is completely blocking, i.e., no sound is let through at all, as well as the case where the occluding object(s) only let through a very small amount of the original sound energy such that it is not contributing enough to have a perceptual impact on the total rendering of the audio source.

A portion of an audio element is completely occluded when, for example, there is a “hard” occluding object on the sound path—i.e., a virtual straight line from the listening position to the portion of the audio element. An example of a hard occluding object is a thick brick wall. On the other hand, the portion of the audio element may be partially occluded when, for example, there is a “soft” occluding object on the sound path. An example of a soft occluding object is thin curtain.

If one or several soft occluding objects are in the sound path, the occlusion effect can be calculated as a filter, which corresponds to the audio transmission characteristics of the material. This filter may be specified as a list of frequency ranges and, for each listed frequency range, a corresponding gain factor (g), which is a function of the occlusion factor. If more than one soft occluding object is in a path, the filters of the materials of those objects can be multiplied together to form one compound filter corresponding to the audio transmission character of that path.

The raytracing can be initiated by specifying a starting point and an endpoint or it can be initiated by specifying a starting point and a direction of the ray in polar format, which means a horizontal and vertical angle plus, optionally a length. The occlusion detection is repeated either regularly in time or whenever there was an update of the scene, so that a renderer has up-to-date occlusion information.

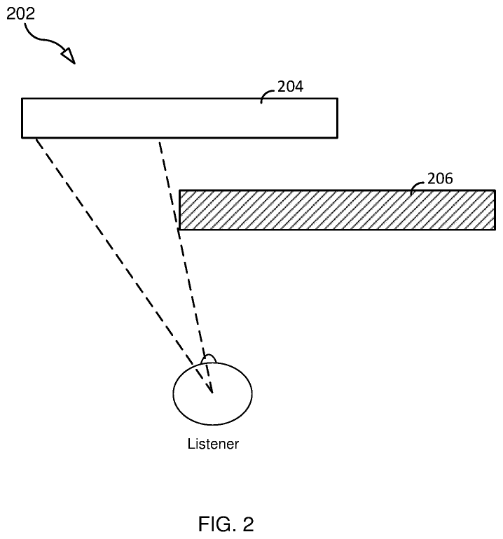

In the case of an audio element 202 with an extent 204, as shown in FIG. 2, the extent of the audio element may be only partly occluded by an occluding object 206. This means that the rendering of the audio element 202 needs to be altered in a way that reflects what part of the extent is occluded and what part is not occluded. The extent 204 may be the actual extent of the audio element 202 as seen from the listener position or a projection of the audio element 202 as seen from the listener position, where the projection may be for example the projection of the extent of the audio element onto a sphere around the listener or a projection of the extent of the audio element onto a plane between the audio element and the listener.

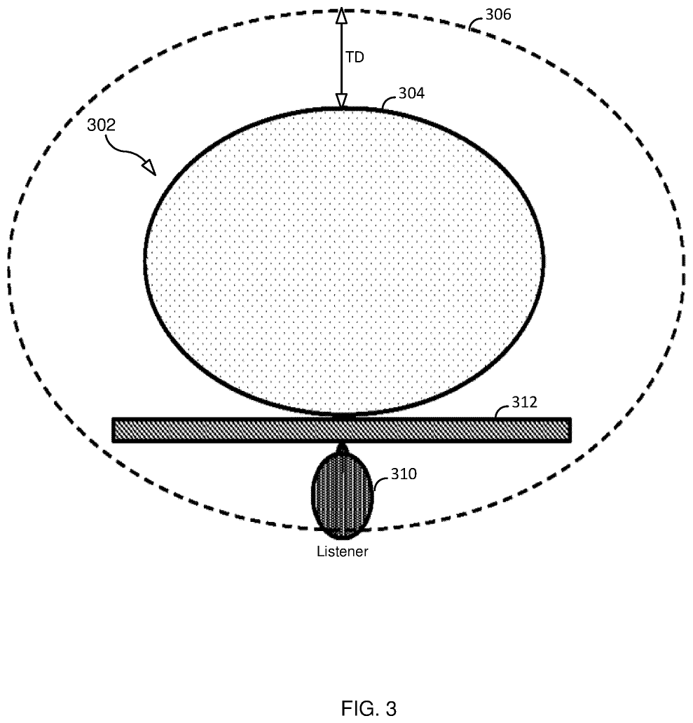

FIG. 3 illustrates a spatially-bounded audio element 302 having an extent 304 and having an exterior and interior representation. Reference [8] describes a method for rendering the audio element, where a transition between the representations is done within a transition region 306 around the extent 304 of the audio element 302, which, in this example, is defined by a single transition distance (TD). That is, the listener 310 is within the transition region 306 if the distance from the listener to the boundary of the extent 304 of the audio element 302 is less than TD.

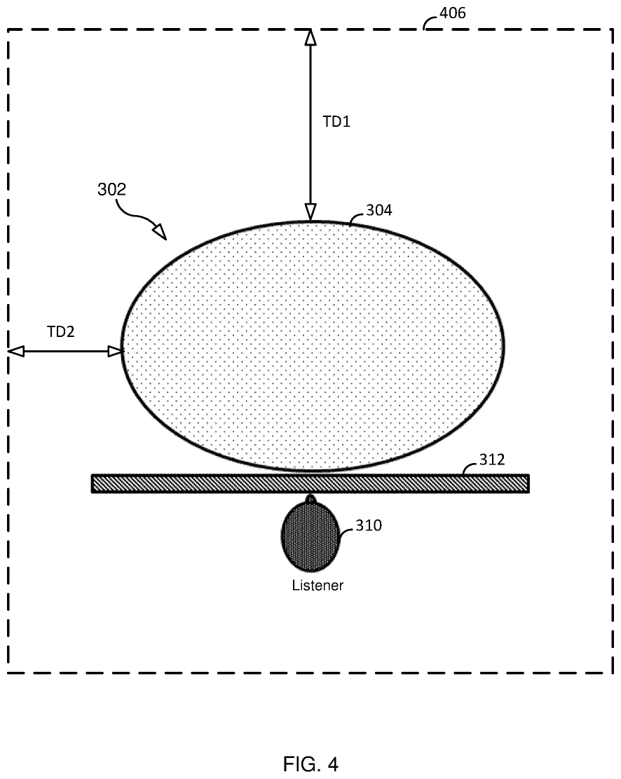

FIG. 4 illustrates another possible transition region 406 that can surround audio element 302. in this example transition region is not defined by a single transition distance (TD), but may be defined by a number of transition distance (two of which, TD1 and TD2, are shown).

In situations where a listener 310 is inside the transition region 306 or 406, but there is an occluding object 312 between the listener 310 and the extent 304 of the audio element 302 where the occluding object occludes the entire extent 304 (as illustrated in FIGS. 3 and 4), the listener 310 should not hear any direct sound from the exterior representation or the interior representation. Listener 310 might hear diffracted sound, early reflections, or late reverb from the audio element 302, but those are rendered separately and are not considered in the modelling of the direct sound.

To avoid the situation that the listener can hear the interior representation when getting within the transition region even if the extent is completely occluded, the occlusion information needs to be used to control the transition.

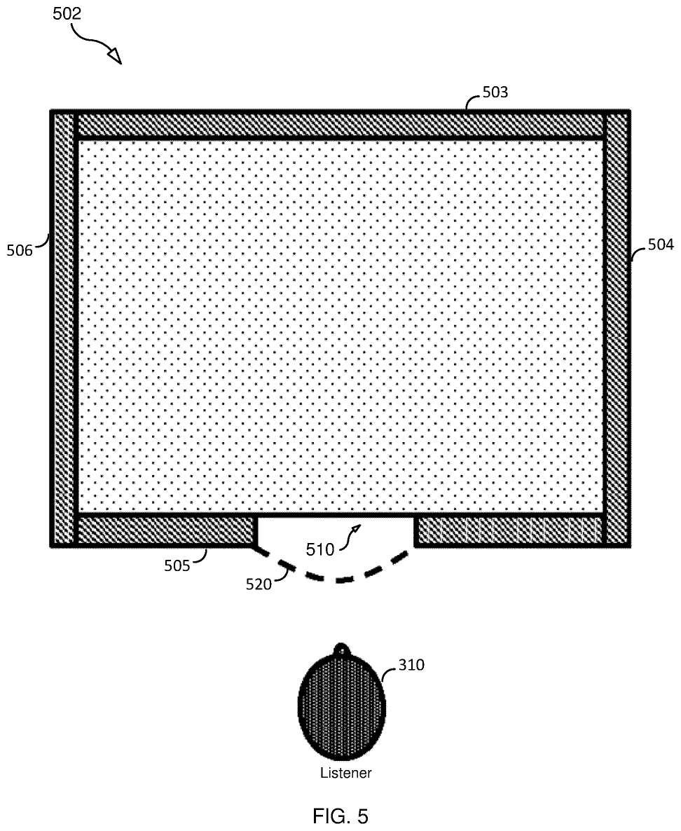

FIG. 5 illustrates another example in which an audio element represents the interior sound of a room 502. The extent of the audio element is set to be the volume of the room. The walls 503, 504, 505, and 506 around the room are hard occluders, which means that the interior representation should not be heard anywhere outside the room, except for when getting close to the door opening 510. An example of a modified outer bounds of the transition region is visualized with a dotted line 520. In this case the listener 310 situated outside the room should not hear the interior representation even if going very close to the wall. Only if there is an opening in the wall, for example a window or door, the listener should hear the interior representation when getting close to the extent.

One way to achieve this is to modify the transition region in response to any detected occlusion. Such a modification can then make sure that the transition region is set to zero area if the extent is completely occluded from the listener position (or zero volume in case the extent is 3-dimensional). And if there is no occlusion, then the transition regions keeps its original dimensions. In cases where the extent is only partly occluded, the original transition region may be modified such that each dimension is reduced in size. An example of such an adaptation for a rectangular transition region (see e.g., FIG. 4, transition region 406) could be:

$${L}^{′} = m \times L ; and$$

$${W}^{′} = m \times W ,$$

where L is the length of the original transition region, L′ is the length of the modified transition region, W is the width of the original transition region, W′ is the width of the modified transition region, and m is a scalar modifier that depends on the amount of occlusion (Ao).

In some embodiment the transition region is defined as a transition distance (see e.g., FIG. 3), which is the distance from the extent of the audio element where the transition region starts. In this case, the transition region can be modified by simply modifying the transition distance. Such a modification can then make sure that, if the extent is completely occluded from the listener position, then the transition distance is set to zero, and, if there is no occlusion, then the transition distance keeps its original length. In cases where the extent is only partly occluded, the transition distance may be set to be shorter than its original length. An example of such an adaptation of a transition distance could be: D′=m×D, where D is the original transition distance and D′ is the modified transition distance.

In one embodiment, the modifier m is set equal to (1−Ao), where Ao is the amount of occlusion, so that if 25% of the extent is occluded, m is set to 0.75.

In the case of soft occlusion, where the occlusion effect of the occluding object is described as a frequency dependent occlusion factor, or some other kind of filter representation, the modifier m may be proportional to the amount of sound energy that is let through by the occluding object. The modifier m may also be frequency dependent so that certain frequency ranges are weighted more than others. For example, the modifier may be proportional to the amount of sound energy that is let through in the range of 0-5 kHz, which would mean that occlusion that only affects the higher frequencies above 5 kHz is not taken into account.

As an alternative to modifying the transition region, the effect of occlusion is taken into account by using a weight, w, which depends on the amount of occlusion Ao and an initial weight, wi, to produce a combined signal, Sc, by mixing an interior representation signal, Si, with an exterior representation signal, Se, as shown below:

$$Sc = wSi + ( 1 - w ) S e .$$

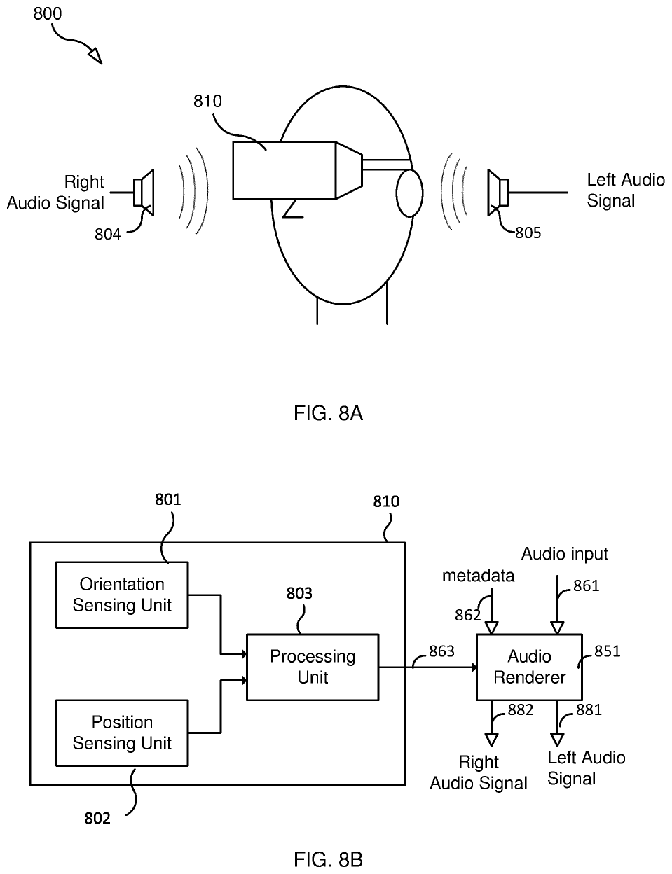

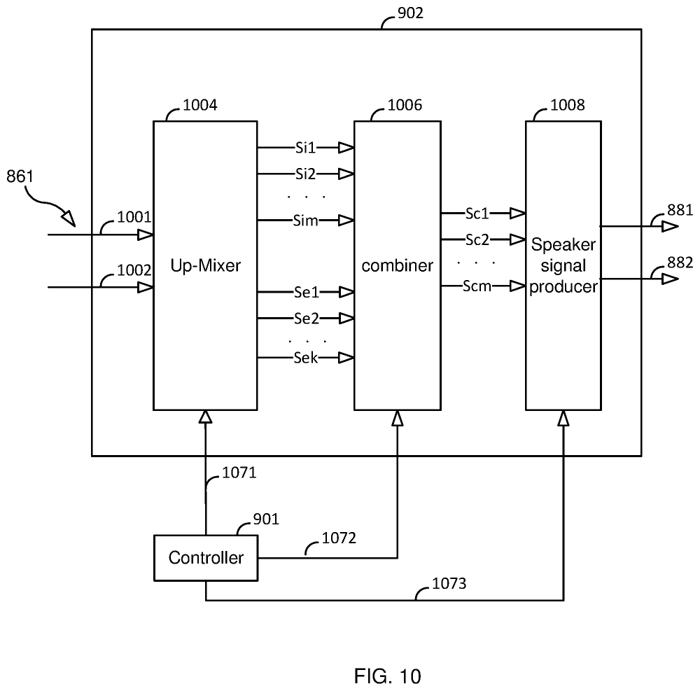

In some embodiments (see, e.g., FIG. 10), m number interior representation signals are generated from an input signal 861 (see FIG. 8B) (i.e., signals Si1, Si2, . . . , Sim are generated) and k number of exterior representation signals are generated from the input signal 861 (i.e., signals Se1, Se2, . . . , Sek are genereated), where m≥k). In this scenario:

$$for j = 1 to k , Scj = wSij + ( 1 - w ) Sej ; and$$

$$for j = k + 1 to m , Scj = wSij .$$

As noted above, w is function of wi and Ao (i.e., w−F(wi, Ao)). The initial weight, wi, corresponds to the amount of the signal of the interior representation that should be used. If wi is 1.0, then only the interior representation is heard (i.e., the listener is within the spatial-boundary of the audio element), and, if wi is 0.0, then only the exterior representation is heard (i.e., the listener is outside of the transition region). If the listener is within the transition region, then, in one embodiment wherein the transition region is defined by a single transition distance (TD), wi=d/TD, where d is the distance from the listener to the edge of the transition region.

The function F( ) can then be designed so that a large amount of occlusion results in a steep curve so that w is kept small until wi is very close to 1.0. An example of such a function is:

$$w = \{ \begin{matrix}0 , & wi < {A}_{O} \\ \frac{wi - {A}_{O}}{1 - {A}_{O}} , & 1 > wi > {A}_{O} \\ 1 , & wi = 1\end{matrix} .$$

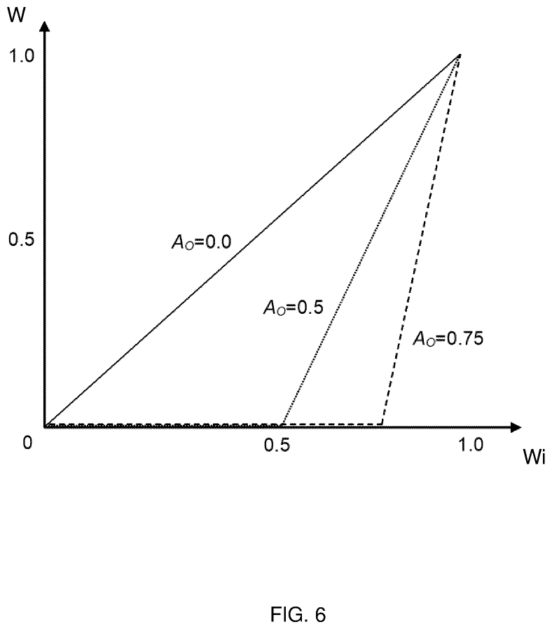

The effect of this function is that w is set to zero unless wi exceeds A_{O} and then increases towards 1.0. This way the transition will start closer to the extent the more occlusion there is. FIG. 6 show the function F( ) for different occlusion amounts.

### Determining Ao

Given knowledge about an occluding object (e.g., a parameter indicating the amount of audio energy from the audio element that passes through the occluding object), an amount of occlusion can be calculated. In a scenario where the parameter indicates that no energy from the audio element passes through the occluding object, then the amount of occlusion can be calculated as the percentage of the audio element that is blocked by the occluding element as seen from the listening position.

In one embodiment, Ao is a function of a frequency dependent occlusion factor (OF) and a P value, where P is the percentage of the audio element that is blocked by the occluding object (i.e., the percentage of the audio element that cannot be seen by the listener due to the fact that the occluding object is located between the listener and the audio element). For example, Ao=OF×P, where OF=Of1 for frequencies below f1, OF=Of2 for frequencies between f1 and f2, and OF=Of3 for frequencies above f2. That is, for a given frequency, different types of occluding objects may have a different occlusion factor. For instance, for a first frequency, a brick wall may have an occlusion factor of 1, whereas a thin curtain of cotton may have an occlusion factor of 0.2, and for a second frequency, the brick wall may have an occlusion factor of 0.8, whereas a thin curtain of cotton may have an occlusion factor of 0.1. In scenarios where the audio element is occluded by more than one occluding object, then Ao is function of the occlusion factor for each occluding object. For example, if there are 2 occluding objects that both cover the exact same portion of the audio element, then, in one embodiment: Ao=COF×P, where COF is a combined occlusion factor that is equal to: 1−((1−OF1)−((1−OF1)×OF2)), where OF1 is the occlusion factor for the first occluding object and OF2 is the occlusion factor for the second occluding object. As another example, if there are 2 occluding objects that both cover different portions of the audio element with no overlap, then, in one embodiment: Ao=(OF1×P1)+(OF2×P2), where P1 is the P value for the first occluding object and P2 is the P value for the second occluding object.

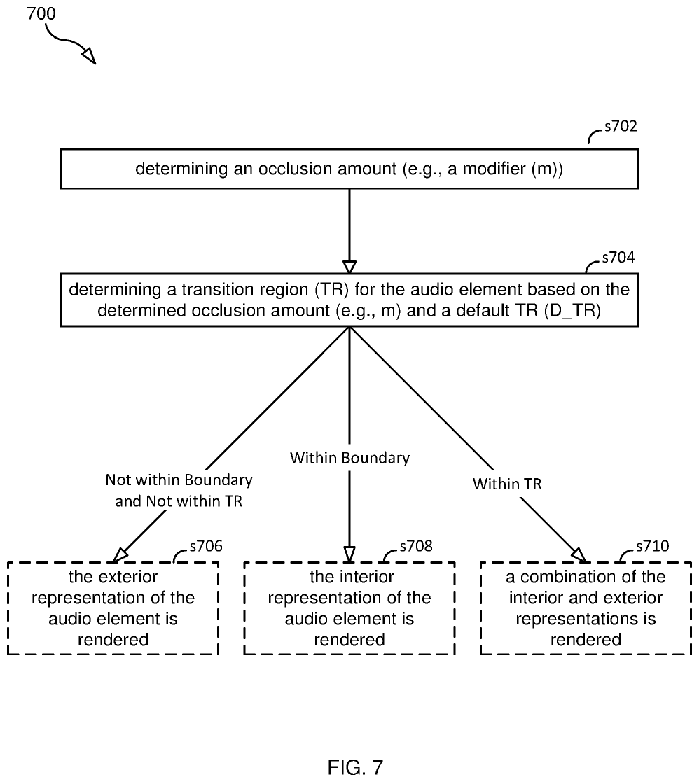

FIG. 7 is a flowchart illustrating a process 700, according to an embodiment, for rendering a spatially-bound audio element having an interior representation and an exterior representation. Process 700 may begin in step s702. Step s702 comprises determining an occlusion amount (e.g., determining a modifier (m)), wherein the occlusion amount indicates an amount by which the audio element is occluded (e.g., m is a function of the amount by which the extent of the audio element is occluded). Step s704 comprises determining a transition region (TR) for the audio element based on the determined occlusion amount (e.g., based on m) and a default TR (D_TR). If the listener is not within the TR and not within the boundary of the audio element, then the exterior representation of the audio element is rendered for the listener (s706), if the listener is within the boundary of the audio element, then the interior representation of the audio element is rendered for the listener (s708), and if the listener is within the TR, then a combination of the interior and exterior representations is rendered for the listener (s710).

### Example Use Case

FIG. 8A illustrates an XR system 800 in which the embodiments may be applied. XR system 800 includes speakers 804 and 805 (which may be speakers of headphones worn by the listener) and a display device 810 that is configured to be worn by the listener. As shown in FIG. 8B, XR system 800 may comprise an orientation sensing unit 801, a position sensing unit 802, and a processing unit 803 coupled (directly or indirectly) to an audio render 851 for producing output audio signals (e.g., a left audio signal 881 for a left speaker and a right audio signal 882 for a right speaker as shown). Audio renderer 851 produces the output signals based on input audio 861, metadata 862 regarding the XR scene the listener is experiencing, and information about the location and orientation of the listener. The metadata for the XR scene may include metadata for each object and audio element included in the XR scene, and the metadata for an object may include information about the dimensions of the object and the occlusion factors (e.g., occlusion gains) for the object (e.g., the metadata for an object may specify a set of occlusion factors where each occlusion factor is applicable for a different frequency or frequency range). Audio renderer 851 may be a component of display device 810 or it may be remote from the listener (e.g., renderer 851 may be implemented in the “cloud”).

Orientation sensing unit 801 is configured to detect a change in the orientation of the listener and provides information regarding the detected change to processing unit 803. In some embodiments, processing unit 803 determines the absolute orientation (in relation to some coordinate system) given the detected change in orientation detected by orientation sensing unit 801. There could also be different systems for determination of orientation and position, e.g. a system using lighthouse trackers (lidar). In one embodiment, orientation sensing unit 801 may determine the absolute orientation (in relation to some coordinate system) given the detected change in orientation. In this case the processing unit 803 may simply multiplex the absolute orientation data from orientation sensing unit 801 and positional data from position sensing unit 802. In some embodiments, orientation sensing unit 801 may comprise one or more accelerometers and/or one or more gyroscopes.

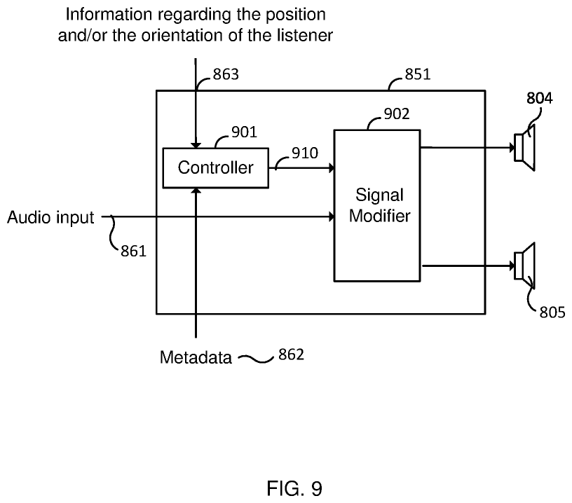

FIG. 9 shows an example implementation of audio renderer 851 for producing sound for the XR scene. Audio renderer 851 includes a controller 901 and a signal modifier 902 for modifying input audio signal(s) 861 (e.g., the audio signals of a multi-channel audio element) based on control information 910 from controller 901. Controller 901 may be configured to receive one or more parameters and to trigger modifier 902 to perform modifications on audio signals 861 based on the received parameters (e.g., increasing or decreasing the volume level). The received parameters include information 863 regarding the position and/or orientation of the listener (e.g., direction and distance to an audio element), metadata 862 regarding an audio element in the XR scene (e.g., audio element 302), and metadata regarding an object occluding the audio element (e.g., object 312) (in some embodiments, controller 901 itself produces the metadata 862). Using the metadata and position/orientation information, controller 901 may calculate one more gain factors (g) for an audio element in the XR scene that is at least partially occluded by one or more occluding objects based on the amount by which each occluding object covers the audio element (e.g., covers an extent of the audio element) and one or more occlusion factors for the occluding objects.

FIG. 10 shows an example implementation of signal modifier 902 according to one embodiment. Signal modifier 902 includes an up-mixer 1004, a combiner 1006, and a speaker signal producer 1008.

Up-mixer 1004 receives audio input 861, which in this example includes a pair of audio signals 1001 and 1002 associated with an audio element, and produces a set of m interior representation signals (i.e., signals Si1, Si2, . . . , Sim) and a set of k exterior representation signals (i.e., signals Se1, Se2, . . . , Sek) based on the audio input and control information 1071. In one embodiment, the signal for each interior and exterior representation signal can be derived by, for example, the appropriate mixing of the signals that comprise the audio input 861. For example: for j=1 to m, Sij=αj×L+βj×R, where L is input audio signal 1001, R is input audio signal 1002, and αj and βj are factors that are dependent on, for example, the position of the listener relative to the audio element and a position associated with Sij. Similarly, for n=1 to k, Sen=αn×L+βn×R, where αn and βn are factors that are dependent on, for example, the position of the listener relative to the audio element and a position associated with Sen. Accordingly, control information 1071 used by up-mixer 1004 to produce the interior and exterior representation signals in some embodiments may include the position information for each interior and exterior representation signal. In one embodiment, the input signals 1001 and 1002 are first up-mixed to four signals using a combination of decorrelation and mixing of the input signals. These up-mixed signals are then mixed to form the signals of the interior and exterior representation.

In some embodiments, when up-mixer 1004 produces m interior representation signals and k exterior representation signals (k≤m), combiner 1006, using control information 1702 provided by controller 901, functions to produce m combined signals as follows:

$$for j = 1 to k , Scj = ϕ Sij + ( 1 - ϕ ) Sej ;$$

and for j=k+1 to m, Scj=ϕSij, where ϕ is w, the above described weight that is dependent on the amount of occlusion, or ϕ is the initial weight wi. In some embodiments, ϕ is included in control information 1702 or the control information 1702 comprises information that enables combiner 1006 to calculate ϕ (e.g., control information comprises information specifying wi and Ao).

Using combined signals Sc1, Sc2, . . . , Scm, speaker signal producer 1008 produces output signals (e.g., output signal 881 and output signal 882) for driving speakers (e.g., headphone speakers or other speakers). In one embodiment where the speakers are headphone speakers, speaker signal producer 1008 may perform conventional binaural rendering to produce the output signals. In embodiments where the speakers are not headphone speakers, speaker signal producer 1008 may perform conventional speaker panning to produce the output signals.

In some embodiments, each combined signal has a corresponding virtual speaker and controller 901 is configured such that, when the audio element is occluded, controller 901 provides to speaker signal producer 1008 position information 1073 comprising a position vector for each virtual speaker so that speaker signal producer 1008 can then use the position vectors to produce the output signals (i.e., signals 881 and 882.). Thus, in one embodiment, the position information comprises the following position vectors: PVS1, PVS2, . . . , PVSm, where for j=1 to m, PVSj is the position vector for the virtual speaker corresponding to combined signal Scj. In one embodiment,

$$for j = 1 to k : PVSj = ϕ PSij + ( 1 - ϕ ) PSej ; and$$

$$for j = k + 1 to m : PVSj = ϕ PSij ,$$

where PSij is a position vector indicating the position associated with interior representation signal Sij and PSej is a position vector indicating the position associated with exterior representation signal Sej.

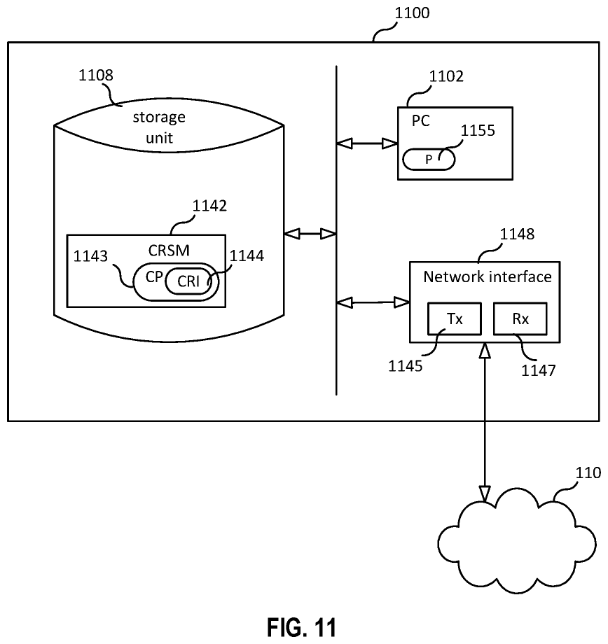

FIG. 11 is a block diagram of an audio rendering apparatus 1100, according to some embodiments, for performing the methods disclosed herein (e.g., audio renderer 851 may be implemented using audio rendering apparatus 1100). As shown in FIG. 11, audio rendering apparatus 1100 may comprise: processing circuitry (PC) 1102, which may include one or more processors (P) 1155 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1100 may be a distributed computing apparatus or a monolithic computing apparatus); at least one network interface 1148 comprising a transmitter (Tx) 1145 and a receiver (Rx) 1147 for enabling apparatus 1100 to transmit data to and receive data from other nodes connected to a network 110 (e.g., an Internet Protocol (IP) network) to which network interface 1148 is connected (directly or indirectly) (e.g., network interface 1148 may be wirelessly connected to the network 110, in which case network interface 1148 is connected to an antenna arrangement); and a storage unit (a.k.a., “data storage system”) 1108, which may include one or more non-volatile storage devices and/or one or more volatile storage devices. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes audio rendering apparatus 1100 to perform steps described herein (e.g., steps described herein with reference to the flow charts). In other embodiments, audio rendering apparatus 1100 may be configured to perform steps described herein without the need for code. That is, for example, PC 1102 may consist merely of one or more ASICs. Hence, the features of the embodiments described herein may be implemented in hardware and/or software.

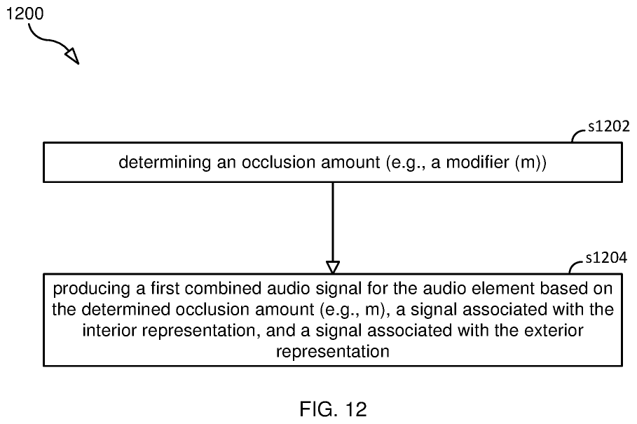

FIG. 12 is a flowchart illustrating a process, according to an embodiment, for rendering a spatially-bounded audio element having an interior representation and an exterior representation. Process 1200 may begin in step s1202. Step s1202 comprises determining a modifier, m, wherein m indicates an amount by which an extent of the audio element is occluded. Step s1204 comprises producing a first combined audio signal, Sc1, for the audio element based on m, a signal, Si1, associated with the interior representation, and a signal, Se1, associated with the exterior representation.

### Summary of Various Embodiments

A1. A method 700 (see FIG. 7) for rendering a spatially-bounded audio element (302) having an interior representation and an exterior representation, the method comprising: determining (s702) an occlusion amount (e.g., m), wherein the occlusion amount indicates an amount by which the audio element is occluded (e.g., the amount by which an extent of the audio element is occluded); and determining (s704) a transition region, TR, for the audio element based on the determined occlusion amount (e.g., based on m) and a default TR, D_TR.

A2. The method of embodiment A1, wherein determining the TR comprising determining a transition distance, TD, for the audio element based on the determined occlusion amount (e.g., based on m) and a default TD, D_TD.

A3. The method of embodiment A2, further comprising obtaining the default TD by calculating D_TD=X×Dim, where X is a predetermined percentage and Dim is a dimension (e.g., length, width, etc.) of an extent of the audio element, or obtaining the default TD by obtaining metadata associated with the audio element, wherein the metadata comprises information indicating the default TD.

A4. The method of embodiment A2 or A3, wherein determining the TD comprises calculating: TD=m×D_TD, where m is based on the determined occlusion amount (e.g., m is the occlusion amount).

A5. The method of embodiment A1, wherein determining the TR comprises calculating: Dim′=m×Dim, wherein m is based on the determined occlusion amount, Dim is a dimension (e.g., length, width, diameter, radius) of the default TR, and Dim′ is a dimension of the TR.

A6. The method of embodiment A4 or A5, wherein m is equal to: 1−Ao, wherein Ao is the determined occlusion amount (e.g., Ao is a value specifying an amount of the extend of the audio element that is occluded).

A7. The method of any one of embodiments A1-A6, wherein one or more occluding objects are occluding the audio element, and determining the occlusion amount, denoted Ao, comprises calculating: Ao=Of×P, where Of is an occlusion factor associated with the one or more occluding objects, and P is the percentage of the audio element that is covered by the one or more occluding objects (e.g., P is the percentage of the extent of the audio element that is covered by the one or more occluding objects). Accordingly, in one embodiment, m is a function of P.

A8. The method of any one of embodiments A1-A7, further comprising: determining whether a listener is within the TR; as result of determining that the listener is within the TR, producing a first combined audio signal, Sc1, wherein Sc1=(w1×Si1)+(w2×Se1), w1 is a first weight value, w2 is a second weight value (e.g., w2=1−w1), Si1 is a first audio signal associated with the internal representation of the audio element, and Se1 is a first audio signal associated with the external representation of the audio element.

A9. The method of embodiment A8 when dependent on embodiment A2, wherein determining whether the listener is within the TR comprises: determining a distance, d, between the listener and the audio element; and determining whether d is less than the TD.

A10. The method of embodiment A8 or A9, further comprising using Sc1 to produce an output audio signal for the listener.

B1. A method 1200 (see FIG. 12) for rendering a spatially-bounded audio element having an interior representation and an exterior representation, the method comprising: determining (s1202) an occlusion amount (e.g., m), wherein the occlusion amount (e.g., m) indicates an amount by which the audio element is occluded (e.g., an amount by which an extent of the audio element is occluded); and producing (s1204) a first combined audio signal, Sc1, for the audio element based on the determined occlusion amount (e.g.,. m), a signal, Si1, associated with the interior representation, and a signal, Se1, associated with the exterior representation.

B2. The method of embodiment B1, further comprising: determining a weight value, w, based on a determined occlusion amount, denoted Ao, wherein: Sc1=(w×Si1)+((1−w)×Se1).

B3. The method of embodiment B2, wherein w is based further on an initial weight, wi.

B4. The method of embodiment B3, wherein determining w comprises comparing wi with Ao.

B5. The method of embodiment B4, wherein determining w further comprises: setting w equal to 0 in response to determining that wi is less than Ao; setting w equal to ((wi−Ao)/(1−Ao)) in response to determining that wi is greater than Ao and less than 1; or setting w equal to 1 in response to determining that wi=1.

B6. The method of embodiment B3, wherein w=Ao×wi

B7. The method of any one of embodiments B1-B6, wherein one or more occluding objects are occluding the audio element, and determining the occlusion amount, denoted Ao, comprises calculating: Ao=Of×P, where Of is an occlusion factor associated with the one or more occluding objects, and P is the percentage of the audio element that is covered by the one or more occluding objects (e.g., P is the percentage of the extent of the audio element that is covered by the one or more occluding objects). Accordingly, in one embodiment, m is a function of P.

B8. The method of any one of embodiments B1-B7, further comprising using Sc1 to produce an output audio signal for the listener.

C1. A computer program comprising instructions which when executed by processing circuitry of an audio renderer causes the audio renderer to perform the method of any one of the above embodiments.

C2. A carrier containing the computer program of embodiment C1, wherein the carrier is one of an electronic signal, an optical signal, a radio signal, and a computer readable storage medium.

D1. An audio rendering apparatus that is configured to perform the method of any one of the above embodiments.

D2. The audio rendering apparatus of embodiments D1, wherein the audio rendering apparatus comprises memory and processing circuitry coupled to the memory.

While various embodiments are described herein, it should be understood that they have been presented by way of example only, and not limitation. Thus, the breadth and scope of this disclosure should not be limited by any of the above described exemplary embodiments. Moreover, any combination of the above-described objects in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] MPEG-H 3D Audio, Clause 8.4.4.7: “Spreading”
[2] MPEG-H 3D Audio, Clause 18.1: “Element Metadata Preprocessing”.
[3] MPEG-H 3D Audio, Clause 18.11: “Diffuseness Rendering”.
[4] EBU ADM Renderer Tech 3388, Clause 7.3.6: “Divergence”.
[5] EBU ADM Renderer Tech 3388, Clause 7.4: “Decorrelation Filters”.
[6] EBU ADM Renderer Tech 3388, Clause 7.3.7: “Extent Panner”.
[7] Efficient HRTF-based Spatial Audio for Area and Volumetric Sources“, IEEE Transactions on Visualization and Computer Graphics 22(4):1-1⋅January 2016.
[8] US Patent Publication 2022/0070606, “SPATIALLY-BOUNDED AUDIO ELEMENTS WITH INTERIOR AND EXTERIOR REPRESENTATIONS,” published Mar. 3, 2022 (Docket P076779).
[9] International Patent Publication WO2021180820, “RENDERING OF AUDIO OBJECTS WITH A COMPLEX SHAPE”, published 16 Sep. 2021 (Docket P080578).
[9] International Patent Application No. PCT/EP2022/059762, filed on Apr. 2, 2022 and titled “RENDERING OF OCCLUDED AUDIO ELEMENTS.” (Docket P102003).
[11] US Patent Publication 2022/0030375, “Efficient spatially-heterogeneous audio elements for Virtual Reality,” published 27 Jan. 2022 (Docket P076758).
[12] International Patent Publication WO2022008595 “SEAMLESS RENDERING OF AUDIO ELEMENTS WITH BOTH INTERIOR AND EXTERIOR REPRESENTATIONS”, published 13 Jan. 2022 (3602-2034) (Docket P081675).

1. A method for rendering a spatially-bounded audio element having an interior representation and an exterior representation, the method comprising:
determining a modifier (m), wherein m indicates an amount by which an extent of the audio element is occluded; and
determining a transition region (TR) for the audio element based on m and a default TR.

2. The method of claim 1, wherein determining the TR comprises determining a transition distance (TD) for the audio element based on m and a default TD, D_TD.

3. The method of claim 2, further comprising
obtaining the default TD by calculating D_TD=X×Dim, where X is a predetermined percentage and Dim is a dimension of the extent of the audio element, or
obtaining the default TD by obtaining metadata associated with the audio element, wherein the metadata comprises information indicating the default TD.

4. The method of claim 2, wherein determining the TD comprises calculating
$$TD = m \times D\_TD .$$

5. The method of claim 1, wherein determining the TR comprises calculating
Dim′=m×Dim, wherein
Dim is a dimension of the default TR, and
Dim′ is a dimension of the TR.

6. The method of claim 4, wherein m is equal to: 1−Ao, wherein Ao is a value specifying an amount of the extent of the audio element that is occluded.

7. The method of claim 1, wherein
one or more occluding objects are occluding the audio element,
m is a function of a value, P, and
P is the percentage of the extent of the audio element that is covered by the one or more occluding objects.

8. The method of claim 1, further comprising:
determining whether a listener is within the TR; and
as result of determining that the listener is within the TR, producing a first combined audio signal, Sc1, wherein
$$Sc 1 = ( w 1 \times Si 1 ) + ( w 2 \times Se 1 ) ,$$
w1 is a first weight value,
w2 is a second weight value,
Si1 is a first audio signal associated with the interior representation of the audio element, and
Se1 is a first audio signal associated with the exterior representation of the audio element.

9. The method of claim 2, wherein the method further comprises:
determining whether a listener is within the TR; and
as result of determining that the listener is within the TR, producing a first combined audio signal (Sc1), where
$$Sc 1 = ( w 1 \times Si 1 ) + ( w 2 \times Se 1 ) ,$$
w1 is a first weight value,
w2 is a second weight value,
Si1 is a first audio signal associated with the interior representation of the audio element, and
Se1 is a first audio signal associated with the exterior representation of the audio element, and
determining whether the listener is within the TR comprises:
determining a distance, d, between the listener and the audio element; and
determining whether d is less than the TD.

10. The method of claim 8, further comprising using Sc1 to produce an output audio signal for the listener.

11. A method for rendering a spatially-bounded audio element having an interior representation and an exterior representation, the method comprising:
determining a modifier (m), wherein m indicates an amount by which an extent of the audio element is occluded; and
producing a first combined audio signal (Sc1) for the audio element based on m, a signal (Si1) associated with the interior representation, and a signal (Se1) associated with the exterior representation.

12. The method of claim 11, further comprising:
determining a weight value (w) based on a determined occlusion amount, denoted Ao, wherein:
$$Sc 1 = ( w \times Si 1 ) + ( ( 1 - w ) \times Se 1 ) .$$

13. The method of claim 12, wherein w is based further on an initial weight (wi).

14. The method of claim 13, wherein determining w comprises comparing wi with Ao.

15. The method of claim 14, wherein determining w further comprises:
setting w equal to 0 in response to determining that wi is less than Ao;
setting w equal to ((wi−Ao)/(m)) in response to determining that wi is greater than Ao and less than 1; or
setting w equal to 1 in response to determining that wi=1.

16. The method of claim 13, wherein w=Ao×wi.

17. The method of claim 11, wherein
one or more occluding objects are occluding the audio element,
m is a function of a value (P), and
P is the percentage of the extent of the audio element that is covered by the one or more occluding objects.

18. The method of claim 11, further comprising using Sc1 to produce an output audio signal for the listener.

19. A non-transitory computer readable storage medium storing a computer program comprising instructions which when executed by processing circuitry of an audio rendering apparatus causes the audio rendering apparatus to perform the method of claim 1.

20. A non-transitory computer readable storage medium storing a computer program comprising instructions which when executed by processing circuitry of an audio rendering apparatus causes the audio rendering apparatus to perform the method of claim 1.

21. An audio rendering apparatus, wherein the audio rendering apparatus is configured to perform a method for rendering a spatially-bounded audio element having an interior representation and an exterior representation, the method comprising:
determining a modifier (m), wherein m indicates an amount by which an extent of the audio element is occluded; and
determining a transition region (TR) for the audio element based on m and a default TR.

22. The audio rendering apparatus of claims 21, wherein determining the TR comprises determining a transition distance (TD) for the audio element based on m and a default TD, D_TD.

23. An audio rendering apparatus, wherein the audio rendering apparatus is configured to perform a method for rendering a spatially-bounded audio element having an interior representation and an exterior representation, the method comprising:
determining a modifier (m), wherein m indicates an amount by which an extent of the audio element is occluded; and
producing a first combined audio signal (Sc1) for the audio element based on m, a signal (Si1) associated with the interior representation, and a signal (Se1) associated with the exterior representation.

24. The audio rendering apparatus of claims 23, wherein
the method further comprises determining a weight value (w) based on a determined occlusion amount, and
$$Sc 1 = ( w \times Si 1 ) + ( ( 1 - w ) \times Se 1 ) .$$
